(19) United States
(12) Patent Application Publication
(10) Pub. No.: US 2011/0240475 A1
(43) Pub. Date: Oct. 6, 2011

(54) CONDUCTIVITY METER AND LIQUID TREATMENT DEVICE

(76) Inventors: Stefan Hother, Wiesbaden (DE); Uwe Lang, Taunusstein (DE); Colin Henderson, Bury (GB); Thomas Kohler, Dreieich (DE)

(21) Appl. No.: 12/998,865

(22) PCT Filed: Dec. 9, 2009
(86) PCT No.: PCT/EP2009/066748

§ 371 Date: Jun. 10, 2011

(30) Foreign Application Priority Data
Dec. 10, 2008 (DE) 10 2008 054 479.5

(51) Int. Cl. G01F 23/24; C02F 1/00

(52) U.S. Cl. 204/674; 73/304 R

(57) ABSTRACT

A conductivity measurement device, at least for the determination of the fill height of electrically conductive liquids. There are provided a measuring element with at least one carrier body and at least two electrodes having a first and a second end and extending in the vertical direction, wherein the electrodes have at least one screened region in the region of the first end and each electrode has at least a first and a second exposed contact surface, each being adjacent to the screened region. A liquid treatment device with such a conductivity measurement device.

### FIELD OF THE INVENTION

The invention concerns a conductivity measurement device at least for the determination of the fill height of electrically conductive liquids comprising a measuring element that has at least one carrier body and at least two electrodes having a first and a second end and extending in the vertical direction. The invention also relates to a liquid treatment device comprising a first receptacle to receive untreated liquid and a second receptacle to receive treated liquid and with a conductivity measurement device, having a measuring element, that has at least one carrier body and at least two electrodes having a first and a second end and extending in the vertical direction.

### BACKGROUND OF THE INVENTION

Such conductivity measurement devices are used in particular for measuring the fill level of water, e.g., in water filter devices, and to determine corresponding flow volumes.

A conductivity measurement device is known from DE 10 2005 035045 A1 with a measuring element that has electrodes on opposite sides of a carrier body, extending in the vertical direction and broadening toward the top, in order to take into account the shape of the receptacle when determining the fill level. One embodiment also calls for rod-shaped electrodes extending in the vertical direction, while the wall of the receptacle obeys an exponential function.

EP 1 589 325 A2 disclosed a conductivity measurement device with a measuring element that likewise has rod-shaped electrodes, having contact surfaces which are continuous from bottom to top.

With such electrodes, it is possible to determine continuously the height of the fill level.

At the start of the fill level measurement, it is often desirable to determine a quality parameter of the liquid, such as the hardness of water, in order to allow for this value, for example, as a correction factor when measuring the fill height.

### SUMMARY OF THE INVENTION

Therefore, it is an object of the invention to provide a conductivity measurement device with which it is possible to determine at least one liquid parameter, without this measurement being falsified by rising fill level during the measurement. It is also an object of the invention to indicate a liquid treatment device that is improved in this regard.

This problem is solved with a conductivity measurement device at least for the determination of the fill height of electrically conductive liquids comprising a measuring element that has at least one carrier body and at least two electrodes having a first and a second end and extending in the vertical direction, wherein the electrodes have at least one screened region in a region of the first end, wherein each electrode has at least a first and a second exposed contact surface, each being adjacent to the screened region, and wherein the vertical dimension of the screened region is larger than the vertical dimension of the first exposed contact surface.

The electrodes have at least one screened region in the region of the first end, wherein each electrode has at least a first and a second exposed contact surface, each being adjacent to the screened region, and wherein the vertical dimension of the screened region is larger than the vertical dimension of the first contact surface.

In a vertical arrangement of the measuring element, the first contact surface is at the bottom and the second contact surface at the top. The screened region is arranged between the two exposed contact surfaces.

It has been found that the first exposed contact surface can be used to carry out such parameter measurements before the start of the fill level measurements with great accuracy, because the screened region provides sufficient time to perform this measurement before the fill level measurements begin.

The vertical dimension of the first contact surfaces should therefore preferably be chosen to be small enough that the measurement time for determining the desired parameter of the liquid is larger than the time elapsing until the complete contacting of the first contact surfaces. Also, the vertical dimension of the screened region should be large enough that the measurement process is completed before the second contact surfaces are reached by the fill level.

On the other hand, the vertical dimension of the screened region should be as small as possible so that the fill level measurements can be carried out through the contacting of the second contact surface as far down as possible.

For example, if 20 ms are required for the parameter measurement, the change in fill level in a time<20 ms should lead to the complete contact of the first contact surface. The vertical dimension of the screened region, on the other hand, must be large enough so that the change in fill level requires a time>20 ms to reach the second contact surface.

It is therefore preferable to adapt the vertical dimension of the first contact surfaces and the vertical dimension of the screened region to a change in time of the fill level.

Thus, at least the vertical dimension of the screened region can be determined from the speed with which the fill level rises and the duration of the parameter measurement.

It is moreover preferable for the vertical dimension of the screened region to be smaller than the vertical dimension of the second contact surface, wherein the vertical dimension of the second contact surface is preferably oriented to the vertical dimension of the liquid receptacle in which the conductivity measurement device is arranged.

Preferably the electrodes are fully embedded in the carrier body in the screened region. This has the advantage that the liquid has no possibility of contacting the electrodes in this screened region, so that no falsification of the parameter measurement can occur.

Preferably, the first exposed contact surface comprises at least the end face at the first end of the electrode. Since the end face only extends in the horizontal direction and has no vertical component, the time for full contacting is very short, so that good measurement accuracy is achieved when determining the desired parameter.

It is also possible to include a lateral surface in the region of the end face as part of the first contact surface if the vertical dimension of this part of the exposed contact surface fulfils the above-mentioned criteria regarding the change in time of the fill level.

According to another embodiment, the electrodes can project downward from the carrier body beyond the lower end of the screened region. In this embodiment as well, one must make sure that the vertical dimension of the side surfaces of the electrodes is small enough to achieve the desired measurement accuracy.

According to another embodiment, channels are formed in the region of the carrier body to receive the electrodes, and the electrodes are set back into these channels. At the start of the filling process the liquid rises inside these channels and contacts the end faces of the electrodes. This embodiment has the advantage that wave movements of the rising liquid exert no influence on the measurement accuracy. The channels must preferably be of such size that the liquid can rise without problems inside the channels to reach the end faces of the electrodes.

According to another embodiment, the first exposed contact surface can also be a lateral surface in the region of the first end of the electrode. The end face in this embodiment is preferably screened.

Preferably, the first exposed lateral contact surfaces of the two electrodes are arranged opposite each other. Thus, these surfaces are arranged in a protected region, so that spray water and the like cannot result in a falsifying of the measured values.

According to a further embodiment, the first exposed lateral surface is placed at a distance from the end face, wherein the end face is preferably screened. This has the advantage that the first contact surface only makes contact with the liquid after a particular fill level. Any wave motions during the first pouring in of liquid have then quieted down as the fill level rises, so that no wrong measurements can occur.

The second exposed contact surface is preferably a lateral surface of the electrodes. This second exposed lateral surface extends from the screened region into the region of the second end of the electrode and is used to determine the height of fill. The vertical dimension of this second contact surface depends on the height of the receptacle in which the conductivity measurement device is arranged.

Preferably the electrodes have a constant cross-section along their length, wherein the cross-section can, for example, be round. This simplifies the production of the electrodes. The electrodes are preferably rod-shaped.

According to a further embodiment, the carrier body is a carrier plate and the electrodes are arranged alongside each other in the plane of the carrier plate. Providing the electrodes on a common carrier plate has the advantage that a unit that can easily be arranged in the respective liquid receptacle is formed.

Preferably the carrier body has a recess at the lower end between the electrodes. In this way, two legs are formed, in which the lower end segments of the electrodes are accommodated, preferably with the screened region.

The recess has the advantage that no liquid film can form between the two electrodes, especially between their end faces, possibly resulting in a false measurement. This configuration likewise favours the runoff of liquid.

Another embodiment to prevent a disruptive liquid film provides that the lower end of the carrier body is slanted.

This slanting, preferably in the transverse direction of the carrier plate, also favours the runoff of residual liquid.

The electrodes can consist of a metal, especially a steel.

The possibility also exists of making the electrodes from an electrically conductive plastic. The carrier body can be made from an electrically nonconductive plastic, regardless of the electrode material.

The use of plastic offers the advantage that the runoff of liquid can be favoured by hydrophobic additives, so that false measurements are prevented.

The device, moreover, preferably comprises an evaluating unit, which preferably also contains the power supply.

The evaluating unit can be situated on the outside. It is also possible to integrate the evaluating unit in the measurement element, so that a compact element is achieved, which can easily be installed in a liquid receptacle.

The invention also relates to a liquid treatment device with a first receptacle to receive untreated liquid and a second receptacle to receive treated liquid and with a conductivity measurement device to determine the fill height of electrically conductive liquids with a measuring element, having a carrier body and at least two rod-shaped electrodes having a first and a second end and extending in the vertical direction. The electrodes have a screened region in the region of the first end, wherein each electrode has at least a first and a second exposed contact surface, each being adjacent to the screened region.

The second contact surface of the electrodes is preferably arranged in the receptacle protected against liquid spray and waves. For this, the measurement element can be arranged next to a wall of the receptacle and the second exposed contact surface of the electrodes can face the wall.

According to another embodiment, a screen can be provided in the receptacle to protect against water spray. Such a screen can be implemented, for example, by a partition wall arranged in the receptacle.

One preferred liquid treatment device is a water treatment device, especially a water filter device.

### BRIEF DESCRIPTION OF THE DRAWINGS

Example embodiments of the invention are explained in further detail with reference to the drawings.

There are shown:

FIG. 1 a side view of a conductivity measurement device with a measurement element,

FIG. 2 a top view of the end face of the measurement element of FIG. 1,

FIG. 3 a cross-section along line III-Ill through the measurement element shown in FIG. 1,

FIG. 4 a side view of a conductivity measurement device according to a further embodiment,

FIG. 5 a side view of a measurement element according to a further embodiment,

FIG. 6 a side view of a measurement element according to a further embodiment,

FIG. 7 a section along line VII-VII through the measurement element according to FIG. 6,

FIG. 8 a front view of a conductivity measurement device according to another embodiment,

FIG. 9 a rear view of the conductivity measurement device shown in FIG. 8, and

FIG. 10 a vertical section through a water treatment device.

### DETAILED DESCRIPTION OF THE INVENTION

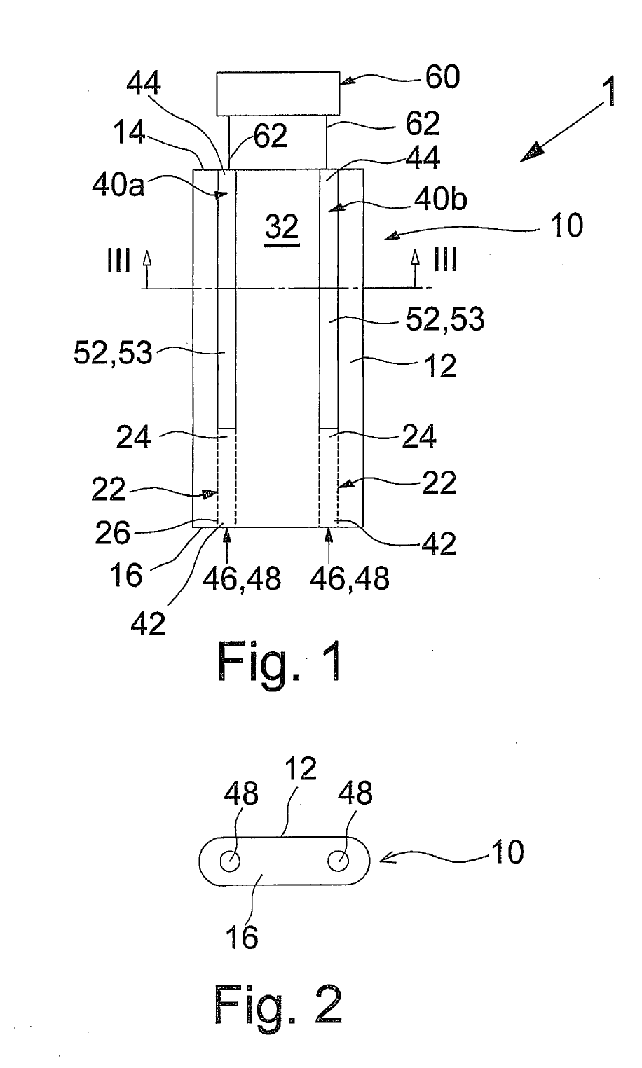

FIG. 1 shows the front side 32 of a conductivity measurement device 1, which comprises a measurement element 10, being connected by connectors 62 to an evaluating unit 60. The evaluating unit 60 preferably also contains its own power supply.

The measurement element has a carrier body 12, on which two electrodes 40a,b are arranged. The carrier body 12 and the electrodes 40a,b extend in the vertical direction.

The electrodes 40a,b have a first exposed contact surface 46, which in the embodiment shown here is formed by the end faces 48 of the electrodes 40a,b. The electrodes 40a,b are flush at their first end 42 with the bottom end of the carrier body 12. Upwardly, a screened region 22 follows on the first exposed contact surface 46. The electrodes 40a,b extending through the screened region 22 are indicated by dashed lines. Upwardly, the second exposed contact surface 52 follows on, which is formed by a lateral surface 53 of the electrodes 40a,b. The electrodes 40a,b extend as far as the upper end 14 of the carrier body 12 and are connected to the connectors 62.

The electrodes 40a,b are partly embedded in the carrier body in the region of the second exposed contact surface 52, so that the back side 34 of the electrodes is also covered in this region. In FIG. 1, the front side 32 of the measurement element is shown.

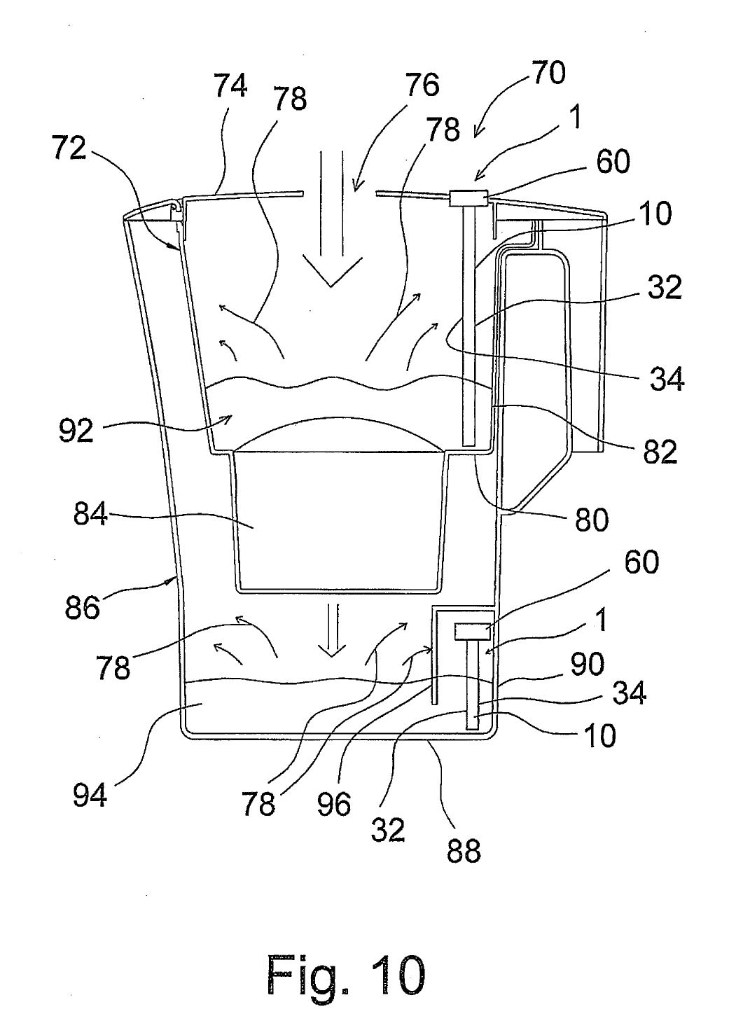

First contact with the liquid being measured occurs via the first exposed contact surface 46, so that a first measurement can be performed to determine a parameter of the liquid. With rising fill level (also see FIG. 10), nothing changes for the contacting of the first exposed surface, because the electrodes in the region 22 above it are shielded. Only when the fill level reaches the upper end 24 of the screened region 22 and makes contact with the second exposed contact surface 52 can the additional measurements to determine the height of fill level be performed.

A certain time will be needed until the fill level rises from the lower end 26 to the upper end 24 of the screened region 22, and this can be used for the measurement at the end faces 48 of the two electrodes 40a,b. The vertical dimension of the screened region 22 is chosen large enough so that sufficient time is available for this measurement at the end faces 48.

FIG. 2 shows the bottom view of the measurement element 10. As can be seen, the electrodes 40a,b are completely embedded in the carrier body 12, and only the end faces 48 are exposed.

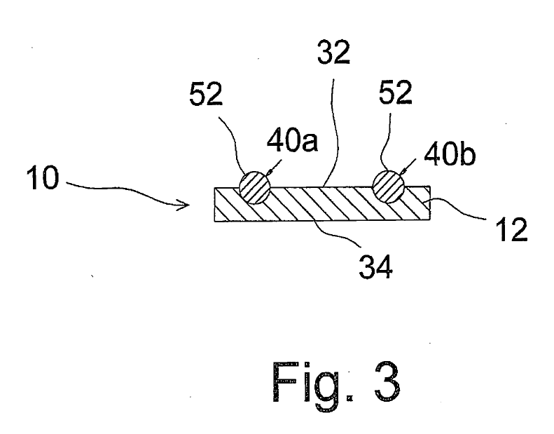

FIG. 3 shows a section along line III-Ill through the device shown in FIG. 1. As can be seen, the electrodes 40a,b have a circular cross section and are embedded with a portion in the carrier body 12. The other part of the electrodes 40a,b is exposed and forms the contact surfaces 52,53.

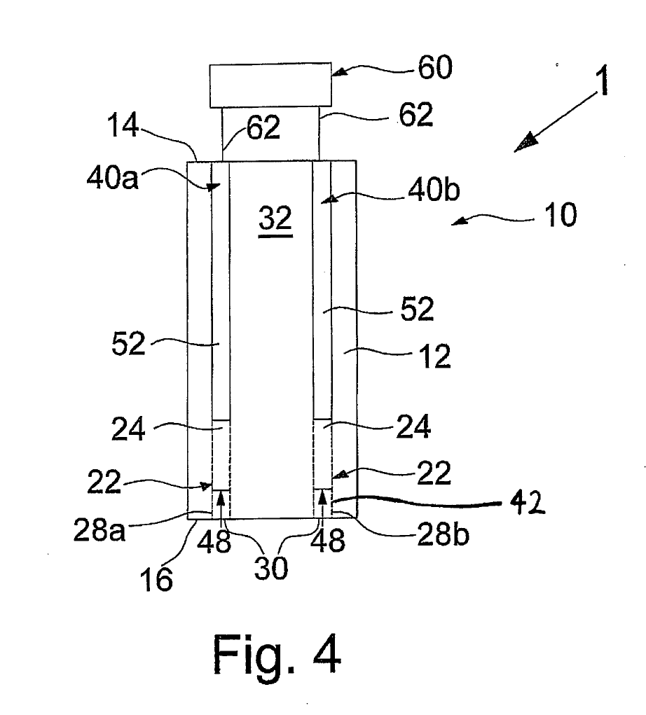

FIG. 4 shows another embodiment that differs from the embodiment shown in FIG. 1 in that the electrodes 40a,b are shortened at the lower end 42. Inside the carrier body 12 there are channels 28a,b situated in the screened region 22, wherein the end faces 48 are located inside these channels 28a,b. The liquid being measured at first rises inside the channels 28a,b until it makes contact with the end faces 48. To facilitate the penetration of the liquid into the channels 28a,b, vent holes can be provided (not shown). Also, in this embodiment, the vertical dimension of the screened region 22 is adapted to the speed of the filling process.

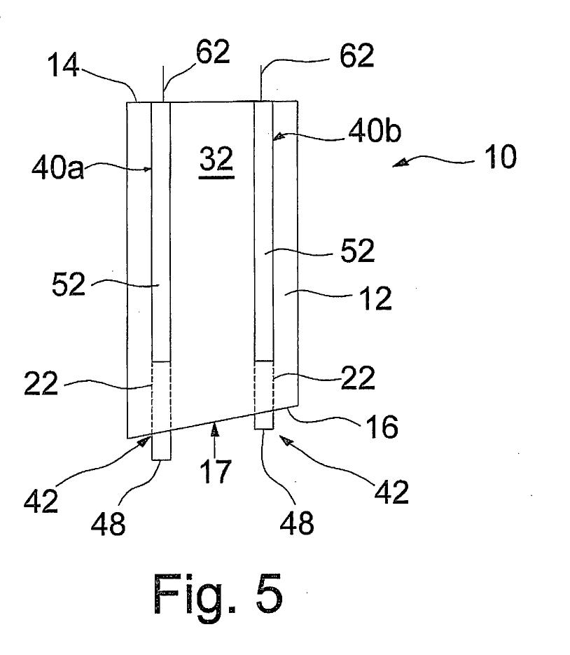

FIG. 5 shows another embodiment having a slanted surface 17 at the lower end 16 of the carrier body 12. This prevents a liquid film from forming between the end faces 48 of the electrodes 40a,b. Thanks to the slanted shape of the lower end face of the carrier body 12, residual liquid can drain off without any problems.

In the embodiment shown here, the two electrodes 40a,b project downward beyond the lower end 16 of the carrier body 12. On account of the slanted surface 17, the first ends 42 of the electrodes 40a,b are staggered in height, in order to assure first contact surfaces 48 of identical size. Not only the end faces 48, but also the adjoining lateral surfaces of the electrodes 40a,b serve as the first free contact surface. The vertical dimension of these lateral surfaces may only be short and must be adapted appropriately to the required measurement time, taking into account the change in the fill level over time. The fill level must reach the screened region as fast as possible, so that the measurement using the first two exposed contact surfaces is not affected by the rising fill level of the liquid.

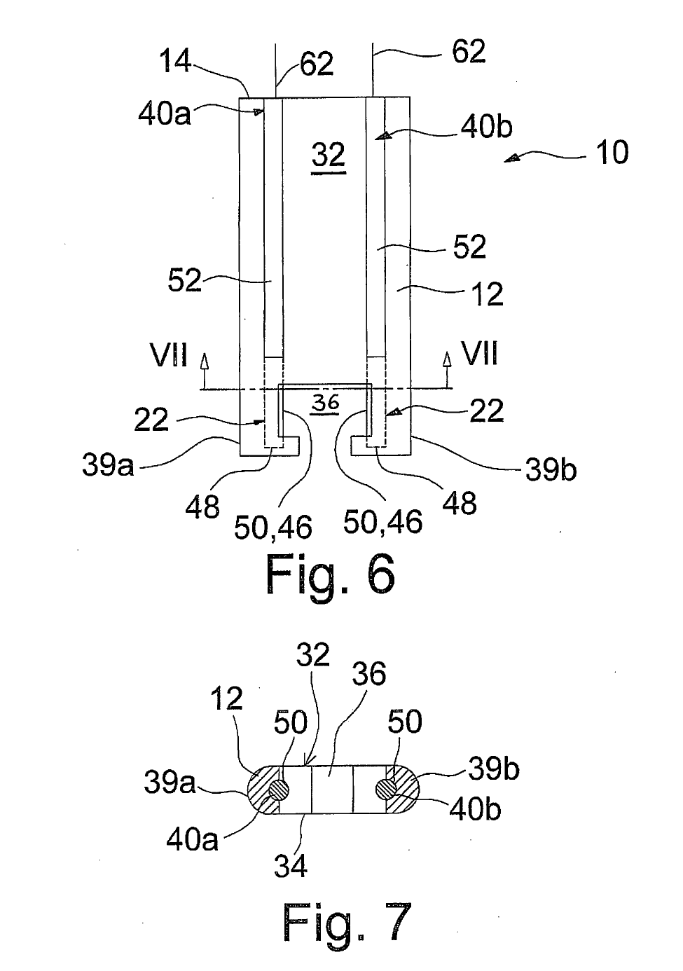

FIG. 6 shows another embodiment in which the screened region 22 also includes the end faces 48 of the electrodes 40a,b. Lateral surfaces 50 of the electrodes just above the end faces 48 are provided as the first exposed contact surfaces. In the embodiment shown here, the carrier body 12 has a window 36, so that the first two contact surfaces 46 which are formed by the lateral surfaces 50 are arranged opposite each other. This arrangement has the advantage that the first two exposed contact surfaces 46 are arranged in a region of calm liquid, and wave motions or spray water do not lead to falsified measurement values.

FIG. 7 shows a section along line VII-VII through this lower region of the measurement element 10 in the region of the window 36. As can be seen, here as well the electrodes 40a,b have a circular cross section and are embedded with one portion in the carrier body 12.

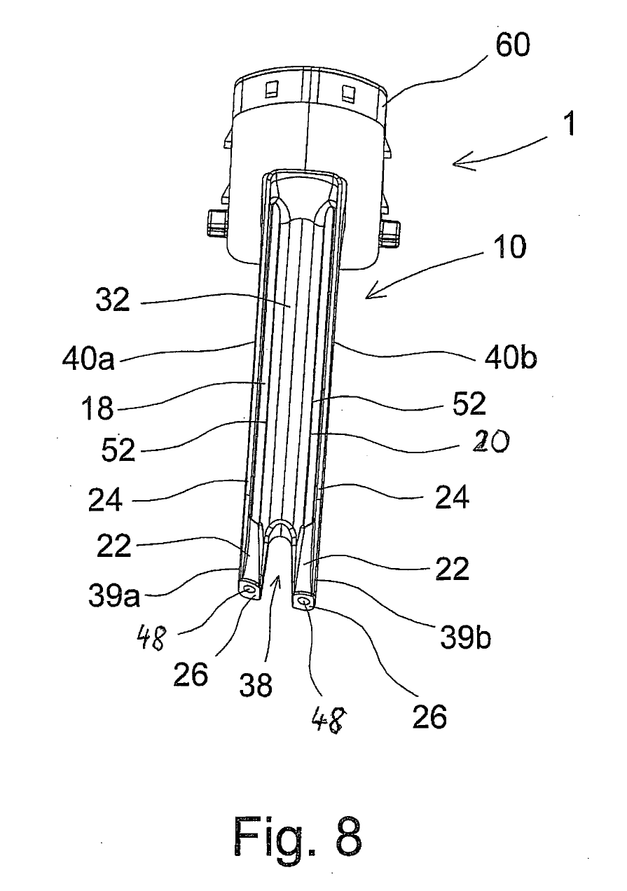

FIG. 8 shows another embodiment, wherein the measurement element 10 has a recess 38 extending in the vertical direction almost over the entire screened region 22. In this way, two legs 39a,b are formed, basically encompassing the screened regions 22.

At the underside of the measurement element 10, one can see the two lateral surfaces 48 of the electrodes 40a,b.

The carrier body 12, as in the preceding embodiments, is shown as an essentially plate-like element. Contrary to the preceding embodiments, the carrier body has two grooves 18 and 20, in which the electrodes 40a,b are arranged. The two exposed contact surfaces 52 are thereby additionally protected against liquid spray and sloshing.

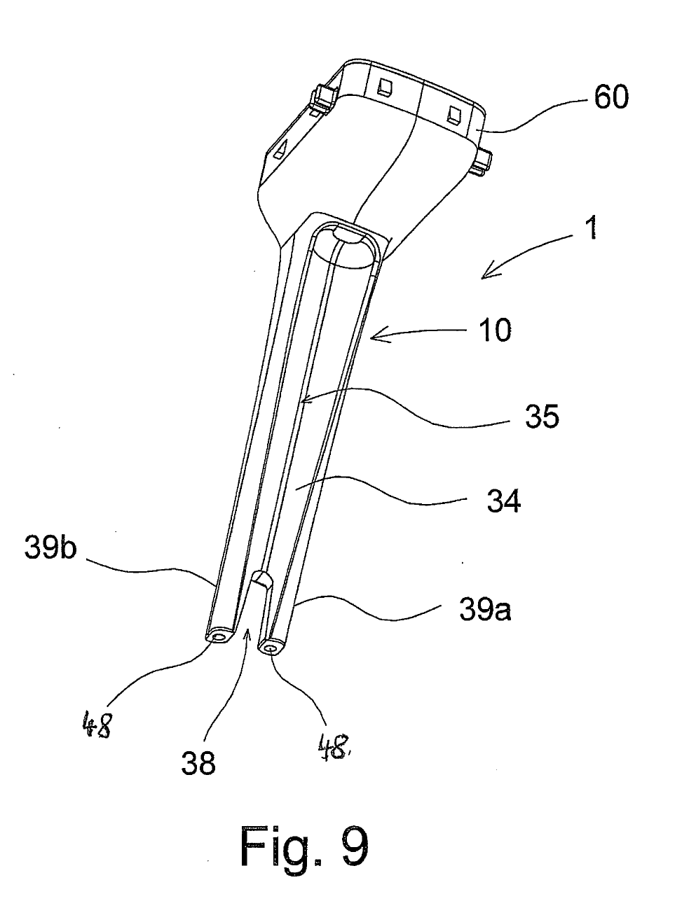

The back side 34 of the measurement element 10 is shown in FIG. 9.

The embodiment according to FIGS. 8 and 9 shows an evaluating unit 60, which is provided as an integral component of the measurement element 10 and arranged at the upper end of the carrier body 12.

FIG. 10 shows a water treatment device 70. This is a water filter device with a water funnel, which forms the first receptacle 72. This first receptacle 72 is arranged [in] a second receptacle 86, which forms a pitcher. In the bottom 80 of the first receptacle there is a filter cartridge 84. The liquid 92 to be filtered is poured into the opening 76 of the lid 74. The liquid passes through the filter cartridge 84 and is filtered there. The filtered water 94 passes at the underside of the filter cartridge 84 into the second receptacle 86 with bottom 88, and is collected there.

In the first receptacle 72, adjacent the right wall 82, a conductivity measurement device 1 is shown schematically. The evaluating unit 60 is arranged in the region of the lid 74 and also preferably comprises a display unit, which is visible from above. This display unit preferably indicates the volume of water which has flowed through the filter cartridge and/or the depletion of the filter cartridge. The measurement element 10, such as has been specified in the previous embodiments, extends downward from the evaluating unit 60. As can be seen, the front side 32, which has the exposed contact surfaces 52, faces the right wall 82. Spray water and slosh water, indicated by the arrows 78, which can occur when pouring in through the opening 76 in the lid 74, at worst splashes against the back side 34 of the measurement element 10 and can thus not reach the exposed contact surfaces 52 on the front side 32. A falsification of the measured values by spray water 78 and slosh water is largely avoided.

Another embodiment provides that a conductivity measurement device 1 is also provided in the second receptacle 86. To illustrate this further embodiment, the back side 34 is turned toward the wall 90 of the second receptacle 86, while the front side 32 carrying the exposed contact surfaces is directed into the interior of the receptacle. In order to keep the spray water 78 which can occur by the emergence from the filter cartridge 84 away from the measurement element 10, the second receptacle 86 has a partition wall 96 in the lower region, which essentially covers the entire front side 32 of the device 1.

### LIST OF REFERENCE NUMERALS

1 conductivity measurement device
10 measurement element
12 carrier body
14 upper end
16 lower end
17 slanted surface
18 groove
20 groove
22 screened region
24 upper end of screened region
26 lower end of screened region
28a,b channel
30 entry opening
32 front side
34 back side
35 cavity
36 window
38 recess
39a,b leg
40a,b electrode
42 first end
44 second end
46 first exposed contact surface
48 end face
50 lateral surface
52 second exposed contact surface
53 lateral surface
60 evaluating unit
62 connector
70 liquid treatment device
72 first receptacle
74 lid
76 pour-in opening
78 spray water and slosh water
80 bottom of the first receptacle
82 right-hand wall of the first receptacle
84 filter cartridge
86 second receptacle
88 bottom of first receptacle
90 wall of the second receptacle
92 unfiltered water/liquid
94 filtered water/liquid
96 partition wall

What is claimed is:

1. A conductivity measurement device at least for the determination of the fill height of electrically conductive liquids comprising: a measuring element that has at least one carrier body and at least two electrodes having a first and a second end and extending in the vertical direction,
wherein the electrodes have at least one screened region in a region of the first end,
wherein each electrode has at least a first and a second exposed contact surface, each being adjacent to the screened region, and
wherein the vertical dimension of the screened region is larger than the vertical dimension of the first exposed contact surface.

2. The device according to claim 1, wherein the vertical dimension of the first exposed contact surface and the vertical dimension of the screened region are adapted to a change in time of the fill level.

3. The device according to claim 1, wherein the vertical dimension of the screened region is smaller than the vertical dimension of the second exposed contact surface.

4. The device according to claim 1, wherein the electrodes are fully embedded in the carrier body in the screened region.

5. The device according to claim 1, wherein the first exposed contact surface comprises at least one end face at the first end of the electrodes.

6. The device according to claim 5, wherein the electrodes project downward from the carrier body beyond a lower end of the screened region.

7. The device according to claim 1, wherein channels are formed in the screened region of the carrier body to receive the electrodes, and the electrodes are set back in the channels.

8. The device according to claim 1, wherein the first exposed contact surface is a lateral surface of the electrodes in the region of the first end of the electrodes.

9. The device according to claim 8, wherein the first exposed lateral surfaces of the two electrodes are arranged opposite each other.

10. The device according to claim 8, wherein the first exposed lateral surface is placed at a distance from an end face.

11. The device according to claim 1, wherein the second exposed contact surface is each time a lateral surface of the electrodes.

12. The device according to claim 1, wherein the second exposed contact surface extends from the screened region into the region of a second end of the electrode.

13. The device according to claim 1, wherein the electrodes have a constant cross-section along their length.

14. The device according to claim 1, wherein the carrier body is a carrier plate, and in that the electrodes are arranged alongside each other in the plane of the carrier plate.

15. The device according to claim 1, wherein the carrier body has a recess at a lower end between the electrodes.

16. The device according to claim 15, wherein the lower end of the carrier body is slanted.

17. The device according to claim 1, wherein the electrodes consist of a metal.

18. The device according to claim 1, wherein the electrodes consist of an electrically conductive plastic.

19. The device according to claim 1, wherein the carrier body consists of an electrically nonconductive plastic.

20. The device according to claim 18, wherein the plastic contains at least one hydrophobically active additive.

21. The device according to claim 1, wherein an evaluating unit is provided.

22. The device according to claim 21, wherein the evaluating unit has a power supply.

23. The device according to claim 21, wherein the evaluating unit is integrated in the measurement element.

24. A liquid treatment device comprising: a first receptacle to receive untreated liquid and a second receptacle to receive treated liquid and with a conductivity measurement device, having a measuring element, that has at least one carrier body and at least two electrodes having a first and a second end and extending in the vertical direction, wherein the electrodes have at least one screened region in the region of the first end, and each electrode has at least a first and a second exposed contact surface, each being adjacent to the screened region.

25. The device according to claim 24, wherein the second exposed contact surface of the electrodes is arranged in a receptacle protected against liquid spray or slosh water.

26. The device according to claim 25, wherein the measuring element is arranged next to a wall of the receptacle and the second exposed surface of the electrodes faces the wall.

27. The device according to claim 25, wherein a screen is provided in the receptacle to protect against water spray and slosh water.

28. The device according to claim 27, wherein a partition wall is arranged in the receptacle as the screen.

29. The device according to claim 24, wherein the device is a water treatment device.
